(19) United States
(12) Patent Application Publication
(10) Pub. No.: US 2025/0379500 A1
(43) Pub. Date: Dec. 11, 2025

(54) ADAPTIVE DRIVE CONTROL FOR SWITCHING REGULATORS

(71) Applicant: QUALCOMM Incorporated, San Diego, CA (US)

(72) Inventors: Troy Lynn STOCKSTAD, Chandler, AZ (US); Yi-Cheng WAN, Singapore (SG); Marko KOSKI, Chandler, AZ (US)

(21) Appl. No.: 18/737,381

(22) Filed: Jun. 7, 2024

(51) Int. Cl. H02M 1/00; H02M 1/08

(52) U.S. Cl. CPC H02M 1/0029; H02M 1/08; H02M 1/0009

(57) ABSTRACT

Certain aspects of the present disclosure relate to techniques and apparatus for adaptive drive control of switching regulators. An example power supply circuit generally includes a power supply rail and a switching regulator power stage. The switching regulator power stage includes a power transistor and an input coupled to the power supply rail. The power supply circuit also includes a transient voltage sensing circuit having an input coupled to the power supply rail and an input voltage sensing circuit having an input coupled to the power supply rail. The power supply circuit further includes control logic having an output coupled to a gate of the power transistor, a first input coupled to an output of the transient voltage sensing circuit, and a second input coupled to an output of the input voltage sensing circuit.

### TECHNICAL FIELD

Certain aspects of the present disclosure generally relate to switching regulators and, more particularly, to adaptive drive control for switching regulators.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter or a buck- boost converter.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

Power management integrated circuits (power management ICs or PMICs) are used for managing the power scheme of a host system and may include and/or control one or more voltage regulators (e.g., buck converters). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure provide a power supply circuit. The power supply circuit generally includes a power supply rail; a switching regulator power stage including a power transistor and an input coupled to the power supply rail; a transient voltage sensing circuit having an input coupled to the power supply rail; an input voltage sensing circuit having an input coupled to the power supply rail; and control logic having an output coupled to a gate of the power transistor, a first input coupled to an output of the transient voltage sensing circuit, and a second input coupled to an output of the voltage sensing circuit.

Certain aspects of the present disclosure provide an integrated circuit. The integrated circuit generally includes the power supply circuit or at least a portion of the power supply circuit described herein.

Certain aspects of the present disclosure provide a method of supplying power. The method generally includes: sensing a transient voltage level at an input of a switching regulator power stage; sensing an input voltage level at the input of the switching regulator power stage; and lowering a slew rate of a control signal for a power transistor of the switching regulator power stage when the transient voltage level is greater than a first threshold voltage level and the input voltage level is greater than a second threshold voltage level.

Certain aspects of the present disclosure provide an apparatus. The apparatus generally includes: means for sensing a transient voltage level at an input of a switching regulator power stage; means for sensing an input voltage at the input of the switching regulator power stage; and means for lowering a slew rate of a control signal for a power transistor of the switching regulator power stage when the transient voltage level is greater than a first threshold and the input voltage is greater than a second threshold.

Certain aspects of the present disclosure provide another method of supplying power. The method generally includes: sensing an input voltage level at an input of a switching regulator power stage; determining a duty cycle associated with an on-time of a power transistor of the switching regulator power stage according to a control signal for the power transistor; and lowering a slew rate of the control signal for the power transistor of the switching regulator power stage when the input voltage level is greater than a threshold voltage level and the duty cycle is greater than an inverse of a switching frequency of the switching regulator power stage.

Certain aspects of the present disclosure provide yet another method of supplying power. The method generally includes: sensing a transient voltage level at an input of a switching regulator power stage; sensing an input voltage level at the input of the switching regulator power stage; determining a duty cycle associated with an on-time of a power transistor of the switching regulator power stage according to a control signal for the power transistor; and lowering a slew rate of the control signal for the power transistor of the switching regulator power stage when at least one of: (i) the transient voltage level is greater than a first threshold voltage level and the input voltage level is greater than a second threshold voltage level or (ii) the input voltage level is greater than the second threshold voltage level and the duty cycle is greater than an inverse of a switching frequency of the switching regulator power stage.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power management integrated circuit (PMIC) and a switched-mode power supply circuit, in which aspects of the present disclosure may be practiced.

FIG. 2 is a circuit diagram of an example power supply circuit, in which aspects of the present disclosure may be practiced.

FIG. 3A is a block diagram of a power supply circuit having a switching regulator power stage and control logic for adaptive drive control of a power transistor in the switching regulator power stage, in accordance with certain aspects of the present disclosure.

FIG. 3B is a circuit diagram of an example implementation of the power supply circuit of FIG. 3A, in accordance with certain aspects of the present disclosure.

FIG. 3C is a circuit diagram of another example implementation of the power supply circuit of FIG. 3A, in accordance with certain aspects of the present disclosure.

FIG. 4 is a graph illustrating improvements in efficiency of a switching regulator when implementing adaptive drive control, in accordance with certain aspects of the present disclosure.

FIG. 5 is a flow diagram of example operations for supplying power, in accordance with certain aspects of the present disclosure.

FIG. 6 is another flow diagram of example operations for supplying power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for adaptive drive control of a switching regulator in which a slew rate for a control signal (e.g., gate signal) that is provided to a power transistor of the switching regulator is automatically adjusted (e.g., lowered) when certain conditions indicative of high transistor stress are present. The lowered slew rate for the control signal lowers the transistor drive strength and allows the power transistor to switch at a slower switching speed to reduce voltage stress on the power transistor. The disclosed techniques further provide automatically adjusting (e.g., raising) the slew rate for the control signal when one or more of the conditions indicative of high transistor stress are no longer present. In this manner, the slew rate of the control signal can be raised to control the power transistor at a higher switching speed and therefore reduce switching losses associated with the switching regulator for greater efficiency. Thus, the lower switching speed may be reserved for instances, such as the high transistor stress condition, in which a lower switching speed is utilized to reduce the voltage stress on the power transistor.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

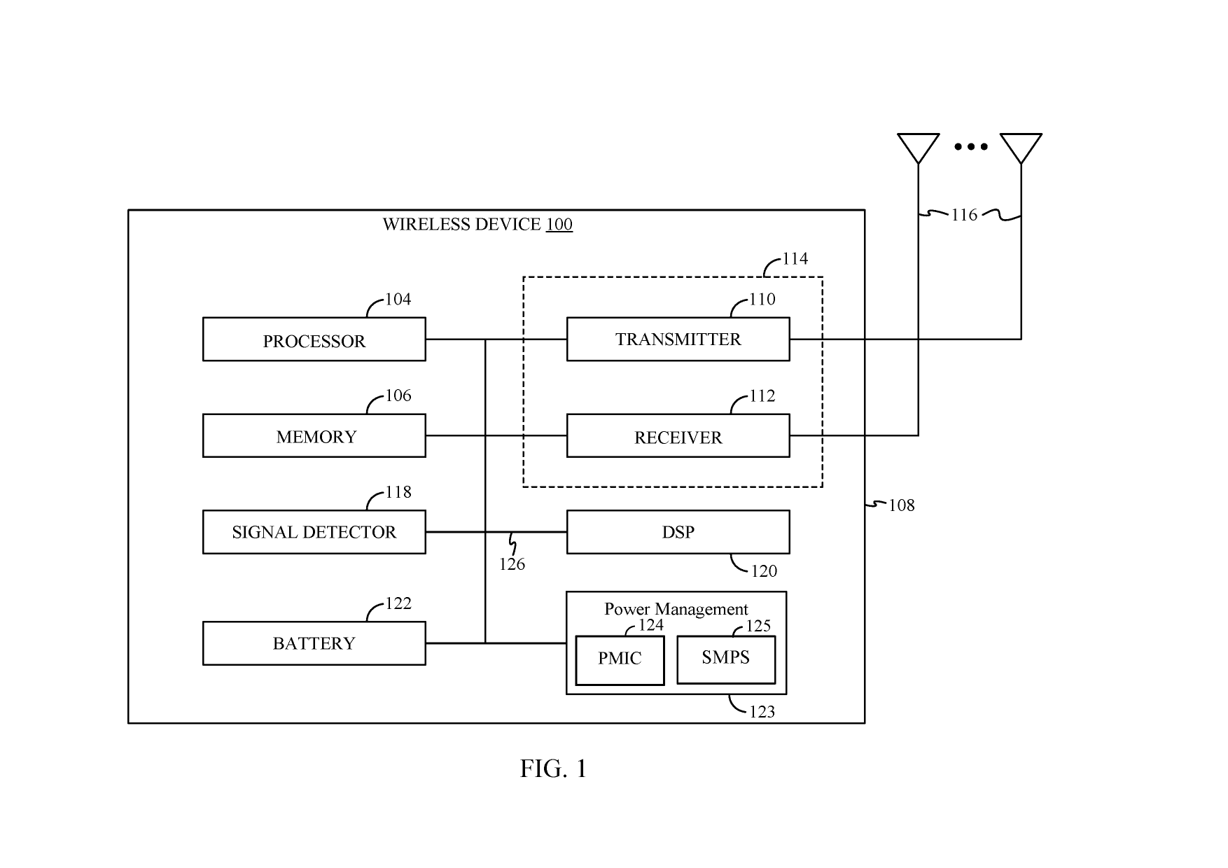

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits. For certain aspects, at least a portion of one or more of the power supply circuits may be integrated in the PMIC 124. The PMIC 124 and/or the one or more power supply circuits may include at least a portion of a switched-mode power supply (SMPS) circuit 125, which may be implemented by any of various suitable switched-mode power supply circuit topologies, such as a buck-boost converter, a two-level buck converter, a three-level buck converter, a charge pump, or an adaptive combination power supply circuit, which can switch between operating in a buck converter mode and a charge pump mode.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Circuit and Operation

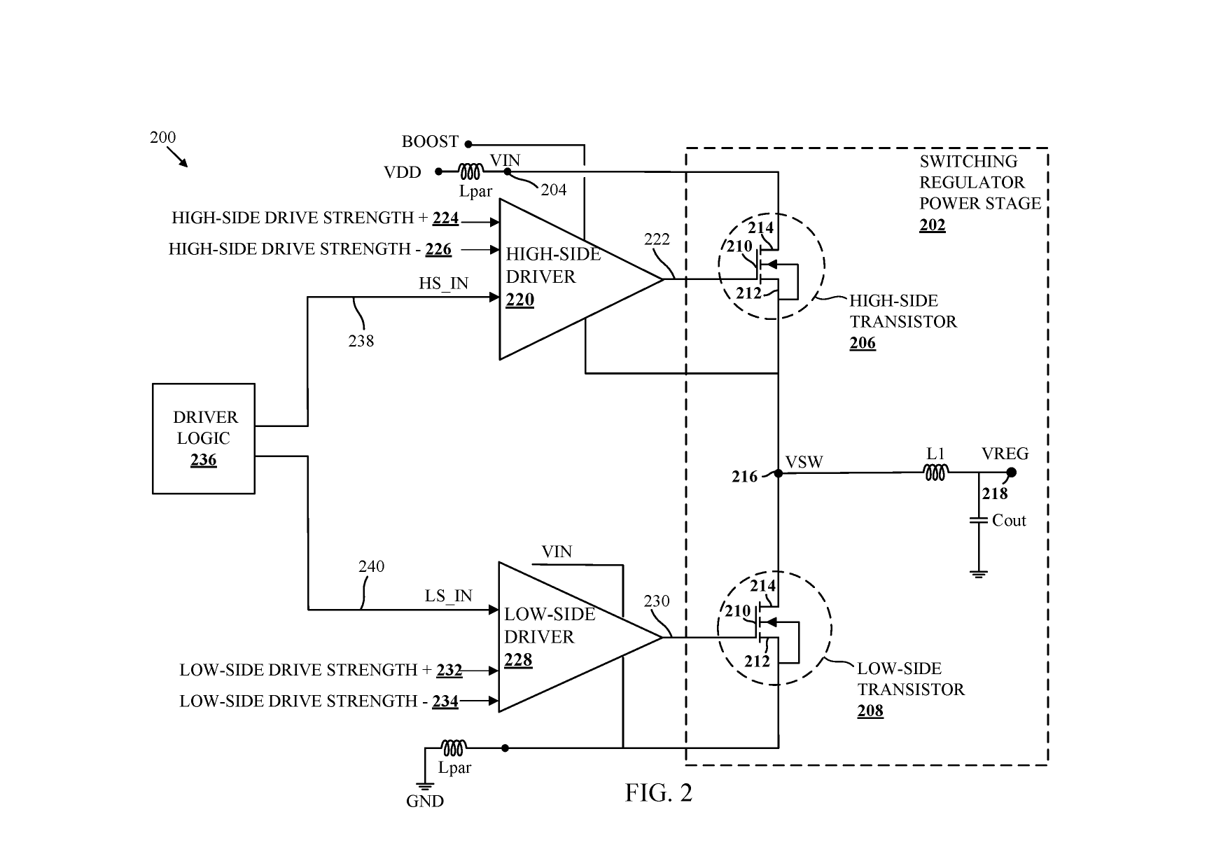

FIG. 2 is a circuit diagram of an example power supply circuit 200. The power supply circuit 200 may be included in the power management system 123 discussed above with reference to FIG. 1. Furthermore, the power supply circuit 200 may include at least a portion of the SMPS circuit 125 discussed above with reference to FIG. 1.

As illustrated, the power supply circuit 200 includes a power supply rail (labeled “VDD”). The power supply circuit 200 further includes a switching regulator power stage 202 which, in certain aspects, may be included in the SMPS circuit 125 (FIG. 1). The switching regulator power stage 202 includes an input 204 coupled to the power supply rail VDD.

In this case, case, the switching regulator power stage 202 is a two-level buck converter and includes two power transistors. For example, the two power transistors include a high-side transistor 206 and a low-side transistor 208. Each of the high-side transistor 206 and the low-side transistor 208 may be implemented as a p-type or an n-type transistor. In the example of FIG. 2, both the high-side and low-side transistors 206, 208 are implemented as n-type field-effect transistors (NFETs). The high-side transistor 206 and the low-side transistor 208 may each include a gate 210, a source 212, and a drain 214. The drain 214 of the high-side transistor 206 is coupled to the input 204 of the switching regulator power stage 202.

The switching regulator power stage 202 includes a switching node 216 (labeled “VSW”). The high-side transistor 206 and the low-side transistor 208 may each be coupled to the switching node 216. For instance, in certain aspects, the source 212 of the high-side transistor 206 may be coupled to the switching node 216, and the drain 214 of the low-side transistor 208 may be coupled to the switching node 216. Furthermore, the source 212 of the low-side transistor 208 may be coupled to a reference potential node for the power supply circuit 200 (e.g., an electrical ground, labeled “GND”), as illustrated.

The switching regulator power stage 202 includes an inductor L1 coupled between the switching node 216 and an output 218 (labeled “VREG” for “regulated voltage”) of the switching regulator power stage 202. The high-side transistor 206 may selectively couple the inductor L1 to the input 204 of the switching regulator power stage 202. For example, the high-side transistor 206 may switch on to allow an electrical current to flow from the input 204 of the switching regulator power stage 202 to the inductor L1. In this manner, energy may, as the electrical current flows through the inductor L1, be stored in a magnetic field of the inductor L1.

The low-side transistor 208 may selectively couple the inductor L1 to the reference potential node of the power supply circuit to discharge the energy in the inductor L1. By controlling the amount of time the high-side transistor 206 is on versus the amount of time the low-side transistor 208 is on, the output voltage VREG of the switching regulator power stage 202 may be regulated and provided to a load (represented in part by an output capacitor C_{OUT}) coupled to the output 218 of the switching regulator power stage 202. It should be understood that the high-side transistor 206 and the low-side transistor 208 control the flow of current and energy transfer within the switching regulator power stage 202 to step down (e.g., lower) an input voltage level VIN at the input 204 of the switching regulator power stage 202 to a regulated voltage level VREG at the output 218 of the switching regulator power stage 202.

The power supply circuit 200 also includes a high-side driver circuit 220 (labeled “HIGH-SIDE DRIVER”) for the high-side transistor 206. The high-side driver circuit 220 may have multiple slew rate control settings (e.g., also known as drive strength settings). For example, the high-side driver circuit 220 may include a first slew rate control setting 224 (labeled “HIGH-SIDE DRIVE STRENGTH +”) and a second slew rate control setting 226 (labeled “HIGH-SIDE DRIVE STRENGTH –”). The first slew rate control setting 224 and the second slew rate control setting 226 may be stored in separate registers. Furthermore, one of the first slew rate control setting 224 or the second slew rate control setting 226 may be manually selected as the slew rate control setting (e.g., during calibration of a device with the power supply circuit 200).

As illustrated, the high-side driver circuit 220 may output a control signal on a gate driver node 222 coupled to the gate 210 of the high-side transistor 206. For an n-type high-side transistor, the control signal may cause the high-side transistor 206 to switch on (activate) when the control signal has a voltage higher than the threshold voltage (Vₜₕ) of the high-side transistor with respect to the voltage at the switching node 216 (e.g., VSW). The high-side transistor 206 may switch off (deactivate) when the control signal is lower than the Vₜₕ of the high-side transistor with respect to VSW.

To keep the high-side transistor 206 on when VSW = VIN, the high-side driver circuit 220 may be powered from a boosted power supply rail (labeled “BOOST”) that provides a gate-to-source voltage (V_{gs}) to the high-side transistor 206 that is higher than VIN. The BOOST rail may be derived from a charge pump (or other suitable power supply circuit) powered from the VDD rail, for example. When the high-side transistor 206 is in the on state (such that VSW = VIN), the BOOST rail allows the high-side driver circuit 220 to provide a control signal with a voltage that is greater than a voltage at the source 212 of the high-side transistor 206. In this manner, the enhanced voltage of the high-side driver circuit 220 may allow the high-side driver circuit 220 to fully turn on the high-side transistor 206.

The power supply circuit 200 also includes a low-side driver circuit 228 (labeled “LOW-SIDE DRIVER”) for the low-side transistor 208. The low-side driver circuit 228 may have multiple slew rate control settings. For example, the low-side driver circuit 228 may include a first slew rate control setting 232 (labeled “LOW-SIDE DRIVE STRENGTH +”) and a second slew rate control setting 234 (labeled “LOW-SIDE DRIVE STRENGTH -”). The first slew rate control setting 232 and the second slew rate control setting 234 may be stored in separate registers. Furthermore, one of the first slew rate control setting 232 or the second slew rate control setting 234 may be manually selected as the slew rate control setting (e.g., during calibration of a device with the power supply circuit 200).

As illustrated, the low-side driver circuit 228 may output a control signal on a gate driver node 230 to the gate 210 of the low-side transistor 208. The control signal from the low-side driver circuit 228 may cause the low-side transistor 208 to switch on and switch off depending on the voltage of the control signal being higher or lower than the Vₜₕ of the low-side transistor 208. Since the switching node may swing between VIN and GND (0 V), the low-side driver circuit 228 may be powered from the input 204 of the switching regulator power stage 202 and the reference potential node, as shown in FIG. 2.

The power supply circuit 200 includes driver logic 236 for controlling the high-side driver circuit 220 and the low-side driver circuit 228. For example, the driver logic 236 may provide a control signal (labeled “HS_IN”) on a control node 238 to a signal input of the high-side driver circuit 220. HS_IN may have a logic level swing based on a digital power supply for the driver logic 236, and the high-side driver circuit 220 may output the control signal on the gate driver node 222 according to HS_IN. Thus, the control signal output from the high-side driver circuit 220 may be a level-shifted version of HS_IN. The control signal on the gate driver node 222 may transition according to the selected slew rate control setting for the high-side driver circuit 220. The driver logic 236 may also provide a control signal (labeled “LS_IN”) on a control node 240 to a signal input of the low-side driver circuit 228. With a logic level swing based on the digital power supply for the driver logic 236, LS_IN may control the low-side driver circuit 228 to output the control signal on the gate driver node 230 accordingly, transitioning with the selected slew rate control setting. Thus, the control signal output from the low-side driver circuit 228 may be a level-shifted version of LS_IN.

In certain aspects, the highest slew rate control setting may be selected for the high-side driver circuit 220. The highest slew rate control setting may also be selected for the low-side driver circuit 228. By selecting the highest slew rate control setting, the power transistors (e.g., high-side transistor 206 and low-side transistor 208) may be switched on and off in a fast switching manner such that transition times at the switching node 216 of the switching regulator are minimized (e.g., less than one nanosecond), or are at least relatively small. In this manner, power losses (e.g., due to switching losses) of the switching regulator power stage 202 may be minimized (or at least reduced).

The power transistors (e.g., high-side transistor 206 and low-side transistor 208) of the switching regulator power stage 202 may experience the highest voltage stress during switching. This is because a rate of change of inductor current (dI/dt) associated with parasitic inductance (e.g., illustrated in FIG. 2 as inductors Lpar, which may be associated with a printed circuit board (PCB) on and/or a semiconductor package in which the switching regulator power stage 202 is implemented) increases the drain-to-source voltage (V_{DS}) of the power transistors higher than the input voltage level VIN of the switching regulator power stage 202.

The V_{DS} of the high-side transistor 206 may be higher than the input voltage level VIN of the switching regulator power stage 202 when a specific set of conditions exists. For example, the V_{DS} of the high-side transistor 206 will be higher than the input voltage level VIN when the high-side transistor 206 is switched off and the load current at the output 218 of the switching regulator power stage 202 is positive. In particular, when the high-side transistor 206 is turned off while the input voltage level VIN is high and the load current is high, the voltage across the parasitic inductance Lpar rings (e.g., as a transient voltage) and can extend the V_{DS} of the high-side transistor 206 significantly higher than the input voltage level VIN of the switching regulator power stage 202.

The V_{DS} of the low-side transistor 208 may be higher than the input voltage level VIN of the switching regulator power stage 202 when a specific set of conditions exists. For example, the V_{DS} of the low-side transistor 208 may be higher than the input voltage level VIN when the load current at the output 218 of the switching regulator power stage 202 is negative. Here again, when the low-side transistor 208 is suddenly turned off, the input voltage level VIN is high, and the load current is high, the voltage across the parasitic inductance Lpar rings (e.g., as a transient voltage) and can extend the V_{DS} of the low-side transistor 208 higher than the input voltage level VIN of the switching regulator power stage 202.

As described above, the slew rate control setting for the high-side driver circuit 220 may be selected (e.g., during calibration, to handle the worst-case conditions). To reduce the voltage stress on the high-side transistor 206 of the switching regulator power stage 202, a lower slew rate control setting (e.g., the second slew rate control setting 226) may be selected to lower the slew rate of the gate drive control signal from the high-side driver circuit 220. The lower slew rate of the control signal reduces the switching speed of the high-side transistor 206 (e.g., during turn off). The slower switching speed of the high-side transistor 206 causes voltage transitions at the switching node 216 to occur at a slower rate (e.g., 5 to 10 nanoseconds) and decreases the dI/dt levels due to the parasitic inductance, which reduces the V_{DS} of the high-side transistor 206. However, the slower transition times at the switching node 216 cause an increase in switching losses, which also decreases efficiency of the switching regulator power stage 202.

### Example Power Supply Circuits Having Adaptive Drive Control for Switching Regulators

Certain aspects of the present disclosure are directed to techniques and apparatus for implementing adaptive drive control for a switching regulator. With adaptive drive control, the switching regulator generally operates in a higher efficiency mode (e.g., with a higher slew rate control setting) and automatically enters an adaptive mode (e.g., with a lower slew rate control setting) when certain conditions are sensed. In this manner, the disclosed techniques provide adaptive drive control of the switching regulator that allow the switching regulator to normally operate with higher drive strength to minimize (or at least reduce) switching losses and automatically change to a lower drive strength to decrease voltage stress on the power transistors under certain conditions. Furthermore, with adaptive drive control, the switching regulator may automatically return to operating with the higher drive strength after certain other conditions are detected.

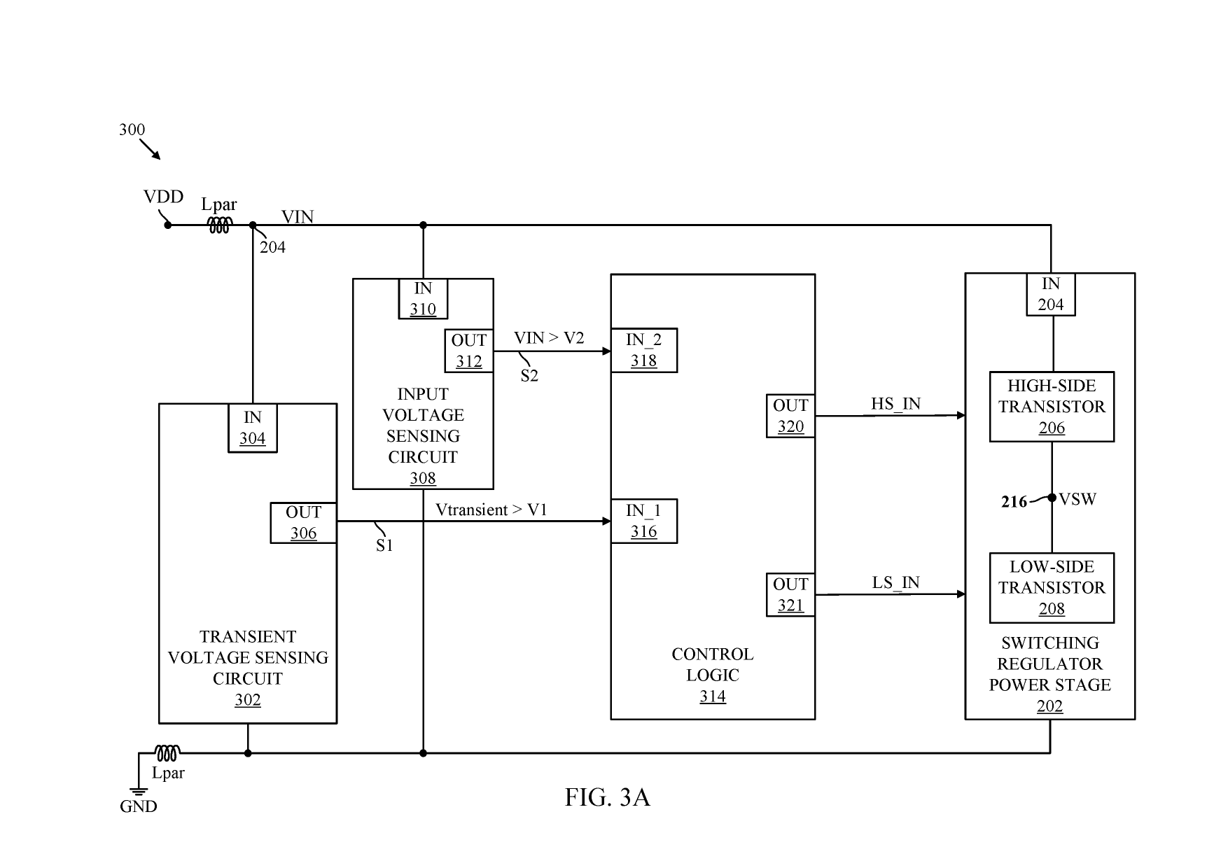

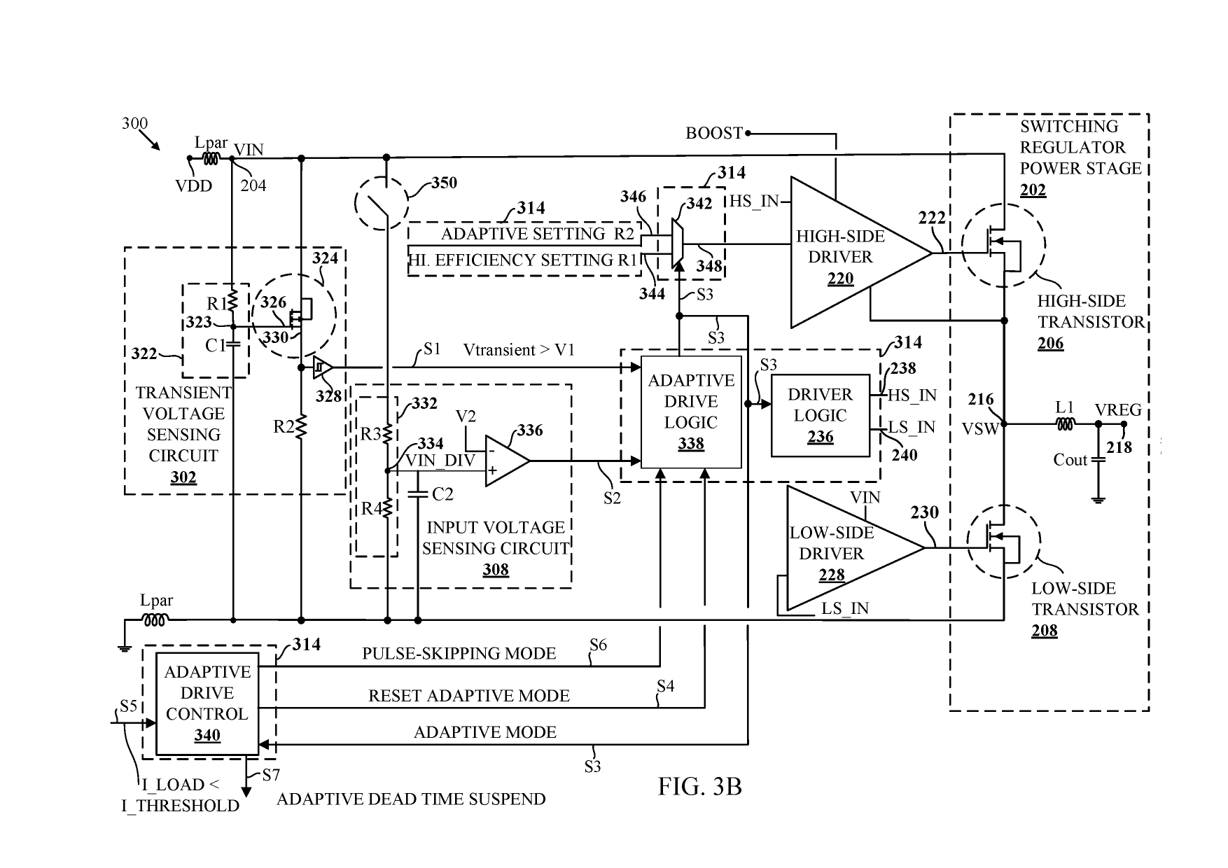

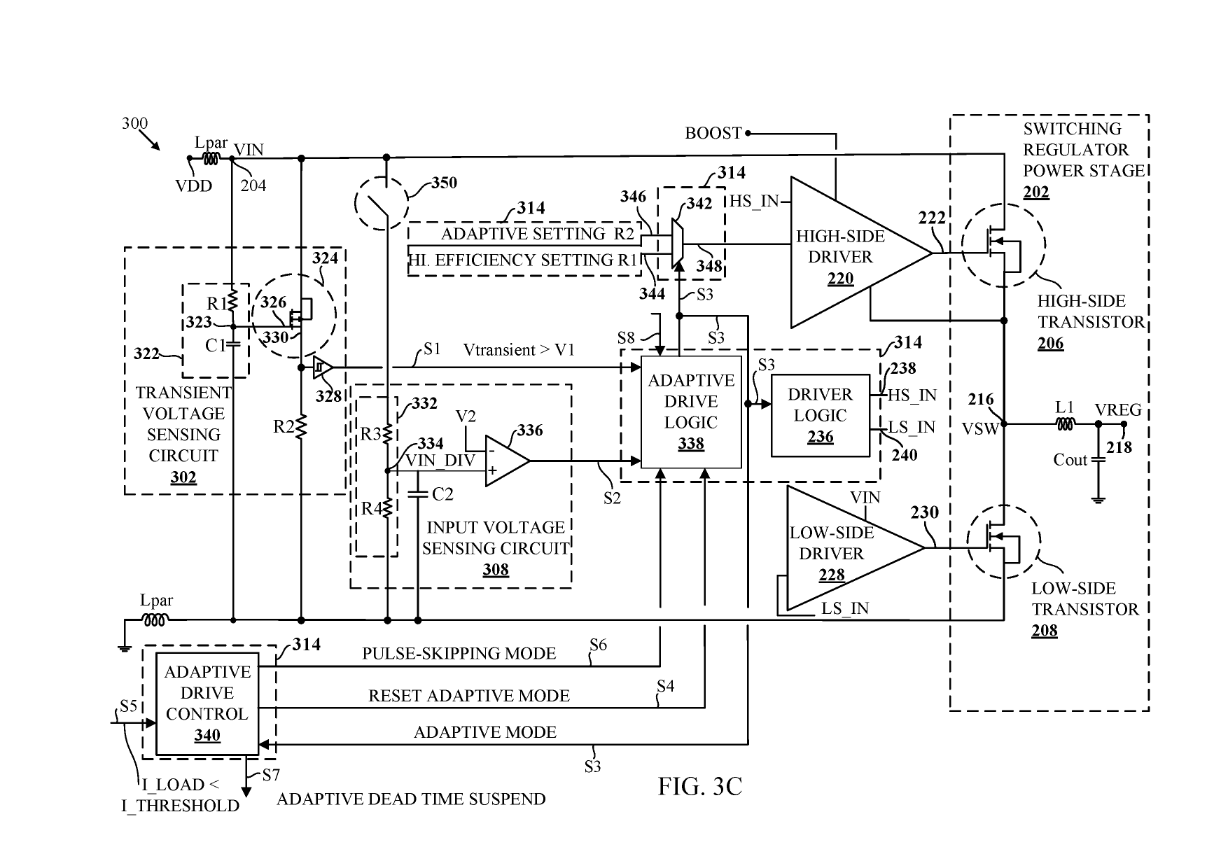

FIG. 3A is a block diagram a power supply circuit 300 with adaptive drive control, in accordance with certain aspects of the present disclosure. As illustrated, the power supply circuit 300 includes the switching regulator power stage 202 discussed above with reference to FIG. 2. It should be understood, however, that the power supply circuit 300 illustrated in FIG. 3A is not limited to including the switching regulator power stage 202 of FIG. 2 and may include other suitable types of switching regulator power stages, such as buck-boost converter power stages. In addition to the switching regulator power stage 202, the power supply circuit 300 includes a transient voltage sensing circuit 302, an input voltage sensing circuit 308, and control logic 314.

The transient voltage sensing circuit 302 includes an input 304 and an output 306. As illustrated, the input 304 of the transient voltage sensing circuit 302 is coupled to the input 204 of the switching regulator power stage 202. In this manner, the transient voltage sensing circuit 302 may sense a transient voltage level (labeled “Vtransient”) at the input 204 of the switching regulator power stage 202, which represents the amount of ringing in the power distribution network for the power supply circuit 300. The transient voltage sensing circuit 302 may also output (e.g., at output 306) a signal S1, which may transition from logic low to logic high when the transient voltage sensed at the input 204 of the switching regulator power stage 202 is greater than a first threshold voltage level (labeled “V1”). The transient voltage sensing circuit 302 may have a power supply input coupled to the reference potential node (e.g., GND) for the power supply circuit 300.

The input voltage sensing circuit 308 includes an input 310 and an output 312. As illustrated, the input 310 of the input voltage sensing circuit 308 is coupled to the input 204 of the switching regulator power stage 202. In this manner, the input voltage sensing circuit 308 may sense the input voltage level VIN (e.g., the DC value of VIN) at the input 204 of the switching regulator power stage 202. The input voltage sensing circuit 308 may also output a signal S2, which may transition from logic low to logic high when the input voltage level VIN sensed at the input 204 of the switching regulator power stage 202 is greater than a second threshold voltage level (labeled “V2”). The input voltage sensing circuit 308 may have a power supply input coupled to the reference potential node (e.g., GND) for the power supply circuit 300.

The control logic 314 includes a first input 316, a second input 318, and outputs 320, 321. As illustrated, the first input 316 may be coupled to the output 306 of the transient voltage sensing circuit 302. In this manner, the transient voltage sensing circuit 302 may provide the signal S1 (e.g., indicating whether Vtransient is greater than V1) to the first input 316 of the control logic 314. In addition, the second input 318 may be coupled to the output 312 of the input voltage sensing circuit 308. In this manner, the input voltage sensing circuit 308 may provide the signal S2 (e.g., indicating whether the DC value of VIN is greater than V2) to the second input 318 of the control logic 314. The outputs 320, 321 of the control logic 314 may be coupled to the switching regulator power stage 202 (e.g., via gate drivers (not shown in FIG. 3A), such as the high-side and low-side driver circuits 220, 228) and may carry the signals HS_IN and LS_IN for controlling the high-side transistor 206 and the low-side transistor 208, as described above for FIG. 2. Thus, the control logic 314 of FIG. 3A may include the driver logic 236 of FIG. 2, as well as additional logic circuitry.

In certain aspects, the control logic 314 may generate, based on signal S1 from the transient voltage sensing circuit 302 and signal S2 from the input voltage sensing circuit 308, a signal S3 (shown in FIGS. 3B and 3C) to control an adaptive mode for the switching regulator power stage 202. For example, the adaptive mode may correspond to a mode of operation in which the drive setting for the high-side driver circuit 220 (illustrated in FIG. 2) for the high-side transistor 206 is switched to a lower drive setting to lower a slew rate of the control signal at the gate driver node 222.

FIG. 3B is an example circuit diagram of the power supply circuit 300, in accordance with certain aspects of the present disclosure. As illustrated, the transient voltage sensing circuit 302 may include a filter 322, a transistor 324, and a comparator 328.

The filter 322 has an input coupled to the input 204 of the switching regulator power stage 202. The filter 322 may be a passive filter and may include one or more resistive elements (e.g., resistor R1) and one or more capacitive elements (e.g., capacitor C1). The output 323 of the filter 322 generally represents a low-pass filtered version of the input 204 of the switching regulator power stage 202 (e.g., the DC voltage level of the input 204).

The transistor 324 may include a gate 326 coupled to an output of the filter 322, a source coupled to the input 204, and a drain 330 coupled to an input of the comparator 328. In this manner, the gate 326 of the transistor 324 may receive the output of the filter 322. As illustrated, in certain aspects, the transistor 324 may be a p-channel metal-oxide semiconductor (PMOS) transistor. In certain aspects, the transient voltage sensing circuit 302 may include a resistor R2 coupled between the reference potential node (e.g., GND) and the drain 330 of the transistor 324 and an input of the comparator 328. The transistor 324 may be designed to be fast enough and to have a certain threshold voltage (Vₜₕ) equal to first threshold voltage level (V1) such that the transistor 324 turns on when a transient signal (e.g., ringing) on the input 204 goes higher than the low-pass filtered version of the input 204 by at least V1.

In certain aspects, the comparator 328 may be a Schmitt trigger. While the transistor 324 is off, the input of the Schmitt trigger is pulled down to a logic low level (e.g., ground) by resistor R2, such that the Schmitt trigger outputs a logic low. The Schmitt trigger may be triggered when the transistor 324 turns on, pulling up the input of the Schmitt trigger to the voltage level at the input 204. While triggered, the Schmitt trigger may output a signal (e.g., signal S1) with a logic high, indicative of the transient voltage sensed at the input 204 of the switching regulator power stage 202 being greater than V1. For other aspects, the comparator 328 may have a positive input coupled to the drain 330 of transistor 324 and a negative input coupled to a reference voltage source.

It should be understood that the transient voltage sensing circuit 302 depicted in FIG. 3B is one example of such a sensing circuit and the scope of the present disclosure is intended to cover other suitable sensing circuits that may be implemented to sense a transient voltage at the input 204 of the switching regulator power stage 202.

As illustrated, the input voltage sensing circuit 308 may include a voltage divider 332 and a comparator 336. The voltage divider 332 may have a resistor R3 and a resistor R4. An input of the voltage divider 332 may be coupled to the input 204 of the switching regulator power stage 202. The voltage divider 332 may receive the input voltage level VIN and output a divided voltage level VIN_DIV at a tap 334 of the voltage divider 332.

The comparator 336 may have a positive input coupled to the tap 334 of the voltage divider 332 and a negative input coupled to a voltage source (not shown) configured to generate a reference voltage at the reference voltage level V2.

The comparator 336 may compare the divided voltage level VIN_DIV to the second threshold voltage level V2. If the divided voltage VIN_DIV is higher than the second threshold voltage level V2, the comparator 336 may output a logic high on signal S2 indicating the divided voltage level VIN_DIV is higher than the second threshold voltage level V2. The comparator 336 may output a logic low on signal S2 when the divided voltage level VIN_DIV is lower than the reference voltage level V2.

In certain aspects, the input voltage sensing circuit 308 may include a capacitor C2 coupled between the positive input of the comparator 336 and the reference potential node (e.g., electrical ground). The capacitor C2 may provide signal conditioning (e.g., low-pass filtering) of the divided voltage level VIN_DIV provided to the positive input of the comparator 328.

As illustrated, the control logic 314 for enabling the adaptive mode of the switching regulator power stage 202 may include multiple components. For instance, the control logic 314 may include adaptive drive logic 338, adaptive drive control 340, and a multiplexer 342. In certain aspects, the control logic 314 may also include the driver logic 236 discussed above with reference to FIG. 2.

In certain aspects, the adaptive drive logic 338 may include a latch circuit having a first input (e.g., the first input 316 discussed above with reference to FIG. 3A) coupled to the output of the transient voltage sensing circuit 302. In this manner, the first input of the latch circuit may receive the signal S1 generated by the transient voltage sensing circuit 302 and indicative of a transient voltage level sensed at the input 204 of the switching regulator power stage 202 being greater than the first threshold voltage level V1. The latch circuit may further include a second input (e.g., the second input 318 discussed above with reference to FIG. 3A) coupled to the output of the input voltage sensing circuit 308. In this manner, the second input of the latch circuit may receive the signal S2 output by the input voltage sensing circuit 308 and indicative of the input voltage level VIN (or the divided voltage level VIN_DIV) sensed at the input 204 of the switching regulator power stage 202 being greater than a reference voltage (e.g., the second threshold voltage level V2).

The latch circuit may enable the adaptive mode of the switching regulator power stage 202 while a transient voltage level sensed at the input 204 of the switching regulator power stage 202 is higher than the first voltage threshold level V1 and the divided voltage level VIN_DIV sensed at the input 204 of the switching regulator power stage 202 is higher than the second voltage threshold level V2. Stated another way, the latch circuit may enable the adaptive mode while the latch circuit receives logic high levels for both signal S1 from the transient voltage sensing circuit 302 and signal S2 from the input voltage sensing circuit 308. To enable the adaptive mode of the switching regulator, the latch circuit may output an enable signal S3. As illustrated, the enable signal S3 may be provided to a control input of the driver logic 236 and a control input of the multiplexer 342. In this manner, the control input of the multiplexer 342 may receive the signal S3 from the latch circuit to select between a normal operating mode and the adaptive mode.

As illustrated, the multiplexer 342 may include a first input 344 coupled to a first register R1 configured to store a first slew rate control setting (labeled “HI. EFFICIENCY SETTING”), which may be used for the normal operating mode. The multiplexer 342 may also include a second input 346 coupled to a second register R2 configured to store a second slew rate control setting (labeled “ADAPTIVE SETTING”). The multiplexer 342 may include an output 348 coupled to a control input of the high-side driver circuit 220. In this manner, the control input of the high-side driver circuit 220 may receive the selected slew rate control setting and control the slew rate of the gate drive signal on the gate driver node 222 coupled to the gate of the high-side transistor 206.

The slew rate of the control signal from the high-side driver circuit 220 provided to the high-side transistor 206 may be highest when the multiplexer 342 provides a first control signal associated with the first slew rate control setting (e.g., HI. EFFICIENCY SETTING) to the control input of the high-side driver circuit 220. Thus, the adaptive drive logic 338 may generally output a logic low enable signal S3 to control the multiplexer 342 to provide the first control signal to the control input of the high-side driver circuit 220. However, the multiplexer 342 may cease outputting the first control signal and instead output a second control signal associated with the second slew rate control setting (e.g., ADAPTIVE SETTING) when the control input of the multiplexer 342 receives a logic high enable signal S3 from the adaptive drive logic 338. In this manner, the slew rate of the control signal from the high-side driver circuit 220 may be lowered to slow the switching speed of the high-side transistor 206 and therefore minimize (or at least reduce) the voltage stress (e.g., V_{DS}) on the high-side transistor 206.

As illustrated, the adaptive drive logic 338 may also provide the enable signal S3 as an input to the adaptive drive control 340. In certain aspects, the adaptive drive control 340 may include a digital controller having an input configured to receive the enable signal S3 from the adaptive drive logic 338.

As illustrated, the adaptive drive control 340 may output a reset signal S4 that is provided to the adaptive drive logic 338. In certain aspects, a pulse on the reset signal S4 may be provided after a predetermined amount of time has lapsed. For instance, the adaptive drive control 340 may be programmed to provide a pulse on the reset signal S4 after a predetermined amount of time has lapsed since the enable signal S3 from the adaptive drive logic 338 transitioned from logic low to logic high. The reset signal S4 may be associated with resetting the adaptive drive logic 338 (e.g., latch circuit). More particularly, the reset signal S4 may cause the adaptive drive logic 338 to output a logic low on the enable signal S3 provided to the multiplexer 342, the driver logic 236, and the adaptive drive control 340, such that the gate drive signal is controlled to operate with the first slew rate control setting (having a higher slew rate).

In some instances, the adaptive drive logic 338 may ignore the reset signal S4 received from the adaptive drive control 340. For instance, the adaptive drive logic 338 may ignore the reset signal S4 if, when the adaptive drive logic 338 receives the reset signal S4, the adaptive drive logic 338 is still receiving a logic high signal S1 from the transient voltage sensing circuit 302 and a logic high signal S2 from the input voltage sensing circuit 308. By ignoring the reset signal S4 in such instances, the adaptive drive logic 338 can continue to output a logic high enable signal S3 to the control input of the multiplexer 342 such that the multiplexer 342 continues to provide the second control signal associated with the lower slew rate control setting (e.g., ADAPTIVE SETTING). In this manner, the control input of the high-side driver circuit 220 can continue to receive the second control setting and therefore can maintain the lower slew rate of the control signal from the high-side driver circuit 220 to, as previously mentioned, allow the high-side transistor 206 to switch at a reduced switching speed and therefore minimize (or at least reduce) voltage stress (e.g., V_{DS}) on the high-side transistor.

In certain aspects, the adaptive drive control 340 may include an input configured to receive a signal S5 indicating a load current (labeled “I_LOAD”) (e.g., an average load current) associated with a load coupled to the output 218 of the switching regulator power stage 202. When the load current indicated by signal S5 is lower than a threshold current value (labeled “I_THRESHOLD,” which may be 4 amps (A)) after operating the power supply circuit 300 in the adaptive mode, the adaptive drive control 340 may reset the adaptive drive logic 338 (e.g., using a logical transition on the reset signal S4). In this manner, when the load current is below the threshold current value, the power supply circuit 300 may cease operating in the adaptive mode (using the second slew rate control setting (ADAPTIVE SETTING) for the high-side drive circuit 220) and return to operating in the normal operating mode with higher drive strength (using the first slew rate control setting (HI. EFFICIENCY SETTING) for the high-side drive circuit 220).

As another example of resetting the adaptive drive logic 338, the adaptive drive control 340 may change logic levels on a signal S6 when the power supply circuit 300 enters a pulse-skipping mode or another discontinuous conduction mode (DCM). Similar to the reset signal S4, the logic transition on signal S6 from the adaptive drive control 340 may cause the adaptive drive logic 338 to reset the power supply circuit 300 to operating in the normal operating mode in the same or a similar manner.

In certain aspects, the power supply circuit 300 may include a switching device 350 coupled between the input 204 of the switching regulator power stage 202 and the input of the input voltage sensing circuit 308. The switching device 350 may be operable to selectively couple the input of the input voltage sensing circuit 308 to the input 204 of the switching regulator power stage 202. When the switching regulator enters the pulse-skipping mode or the control logic 314 otherwise wishes to disable adaptive drive control capability, the adaptive drive control 340 may control operation of the switching device 350 to decouple the input voltage sensing circuit 308 from the input 204 of the switching regulator power stage 202. Opening the switching device 350 reduces energy consumption of the power supply circuit 300 (e.g., by not drawing current through the voltage divider 332).

In certain aspects, the adaptive drive control 340 may output a signal S7 in response to receiving a logic high on the enable signal S3 from the adaptive drive logic 338. The signal S7 may be provided to an adaptive dead time circuit (not shown) and may cause the adaptive dead time circuit to adjust a dead time of the power transistors due, at least in part, to the slower transition time of the switching node 216 of the switching regulator power stage 202 due, at least in part, to the high-side driver circuit 220 applying the slower slew rate control setting. More specifically, the adaptive dead time circuit can increase the dead time of the power transistors to account for the slower transition time of the switching node 216 and therefore avoid cross-conduction that may occur if the dead time were not adjusted (e.g., increased) to account for the slower transition time of the switching node 216.

FIG. 3C depicts another circuit diagram of the power supply circuit 300, in accordance with aspects of the present disclosure. The circuit diagram of the power supply circuit 300 depicted in FIG. 3C is substantially similar to the circuit diagram of the power supply circuit 300 depicted in FIG. 3B. However, the adaptive drive logic 338 of the power supply circuit 300 in FIG. 3C includes an additional input. More specifically, the additional input is related to a duty cycle associated with a power transistor of the switching regulator power stage 202, such as the high-side transistor 206.

In certain aspects, the power supply circuit 300 (e.g., the control logic 314) may determine a duty cycle associated with an on-time of the high-side transistor 206 of the switching regulator power stage 202. This on-time of the high-side transistor 206 may be based on the control signal for the high-side transistor, either HS_IN or the output the high-side driver circuit 220 provides to the gate 210 of the high-side transistor 206. Furthermore, the power supply circuit 300 may determine the duty cycle associated with the on-time of the high-side transistor 206 is greater than an inverse of a switching frequency of the switching regulator power stage 202. When the power supply circuit 300 makes such a determination, a signal S8 provided to an input (e.g., a third input) of the adaptive drive logic 338 may indicate this determination, with a logic level transition. This high duty cycle event would be in response to a large increase in the load current, often called a “load attack.”

In certain aspects, the adaptive drive logic 338 may be programmed to output the enable signal S3 when the adaptive drive logic 338 receives logic level transitions from both the signal S2 from the input voltage sensing circuit 308 and the signal S8 indicating the duty cycle associated with the on-time of the high-side transistor 206 is greater than the inverse of the switching frequency of the switching regulator power stage 202. Thus, the adaptive drive logic 338 of the power supply circuit 300 depicted in FIG. 3C differs from the adaptive drive logic 338 of the power supply circuit 300 depicted in FIG. 3B in that the adaptive drive logic 338 may output a logic high on the enable signal S3 based on the proper logic transitions for signal S1 and S2 only (without considering signal S8), for signals S2 and S8 only (without considering signal S1), or for signals S1, S2, and S8.

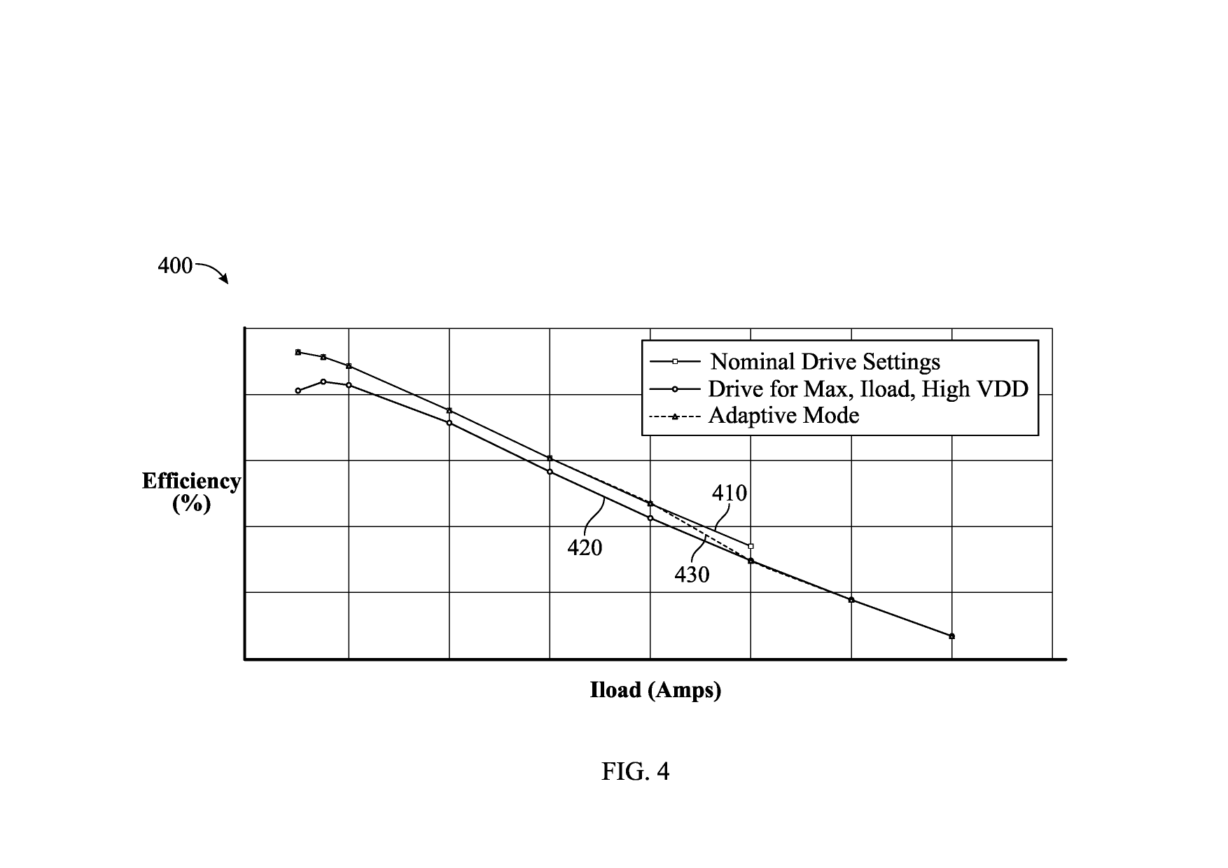

FIG. 4 depicts a graph 400 illustrating efficiency of a switching regulator as a function of a load current, in accordance with aspects of the present disclosure. The graph 400 includes a first curve 410 denoting efficiency of a first switching regulator including power transistors that are driven according to more aggressive slew rate control settings (e.g., the HI. EFFICIENCY SETTING discussed above with reference to FIG. 3B) for all load currents (e.g., light-load currents and high-load currents) for higher efficiency, as illustrated. The graph 400 includes a second curve 420 denoting efficiency of a second switching regulator including power transistors that are driven according to more conservative, worst-case slew rate control setting (e.g., the ADAPTIVE SETTING discussed above with reference to FIG. 3B) for all load currents, for extended load current capability, but with lower efficiency, as shown. The graph 400 includes a third curve 430 denoting efficiency of a third switching regulator implanting the disclosed adaptive drive control techniques such that a power transistor of the third switching regulator is driven according to a highest slew rate control setting for lighter load currents and a lower slew rate control setting for higher load currents.

As illustrated, the adaptive drive control techniques allow the third switching regulator to have improved efficiency at lighter load currents compared to the second switching regulator having the power transistor that is always driven according to the more conservative slew rate control setting. Additionally, the adaptive drive control techniques allow the third switching regulator to handle higher load currents that the first switching regulator having the power transistor that is always driven at a more aggressive slew rate control setting cannot handle. Furthermore, the adaptive control techniques allow the third switching regulator to match the efficiency of the second switching regulator at the higher load current conditions while minimizing (or at least reducing) voltage stress (e.g., Vds) on the power transistor due to the higher load currents. In this manner, the graph 400 illustrates the extended current capability without penalizing performance (e.g., efficiency) of a switching regulator implementing the adaptive drive control.

### Example Operations for Supplying Power

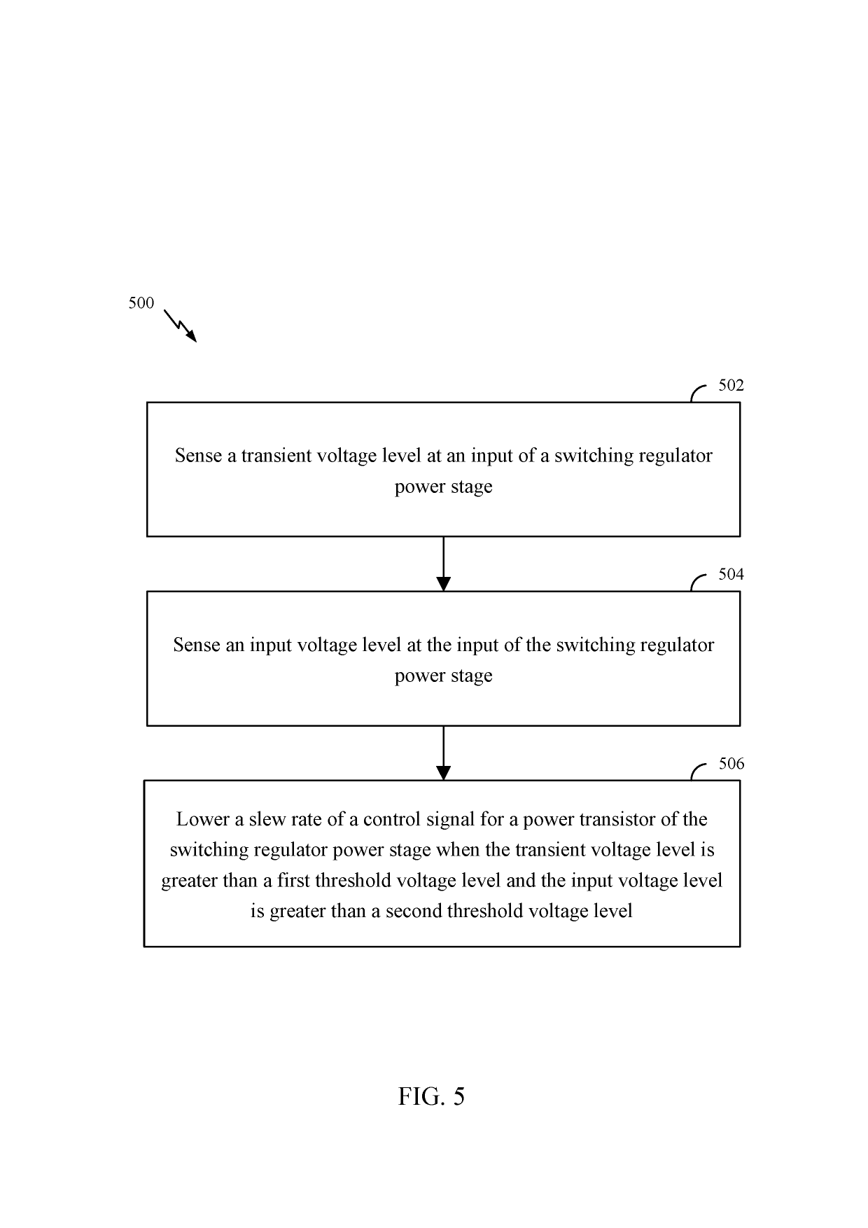

FIG. 5 is a flow diagram of example operations 500 for supplying power, in accordance with certain aspects of the present disclosure. The operations 500 may be performed by a power supply circuit (e.g., the power supply circuits 300 of FIGS. 3A-3C).

The operations 500 may begin, at block 502, with the power supply circuit sensing a transient voltage level at an input (e.g., input 204) of a switching regulator power stage (e.g., switching regulator power stage 202). For instance, the transient voltage level may be sensed by a transient voltage sensing circuit (e.g., transient voltage sensing circuit 302) having an input coupled to the input of the switching regulator power stage.

The operations 500 may continue, at block 504, with the power supply circuit sensing an input voltage level at the input of the switching regulator power stage. For instance, the input voltage level may be sensed by an input voltage sensing circuit (e.g., input voltage sensing circuit 308) having an input coupled to the input of the switching regulator power stage.

When the transient voltage level sensed at block 502 is greater than a first threshold voltage level and the input voltage level sensed at block 504 is greater than a second threshold voltage level, then at block 506 the power supply circuit lowers a slew rate of a control signal for a power transistor (e.g., high-side transistor 206) of the switching regulator power stage.

According to certain aspects, the operations 500 may further involve the power supply circuit sensing an output current (e.g., Iload) of the switching regulator power stage subsequent to lowering the slew rate of the control signal at block 506. The operations 500 may further involve the power supply circuit increasing (e.g., raising) the slew rate when the output current is less than a threshold current.

According to certain aspects, the operations 500 may further involve the power supply circuit determining a duty cycle associated with an on-time of the power transistor according to the control signal for the power transistor of the switching regulator power stage. When the duty cycle is greater than an inverse of a switching frequency of the switching regulator power stage (e.g., greater than the switching period), the operations 500 may further involve the power supply circuit lowering the slew rate of the control signal for the power transistor of the switching regulator power stage.

According to certain aspects, the operations 500 may further involve the power supply circuit raising the slew rate when at least one of: the transient voltage level is no longer greater than the first threshold voltage level, the input voltage level is no longer greater than the second threshold voltage level, a load current of the switching regulator power stage reduces below a threshold level (e.g., 4A), the power supply circuit enters a pulse-skipping mode, or after a programmable period (e.g., a reset period) has elapsed.

According to certain aspects, lowering the slew rate at block 506 involves the power supply circuit setting a latch circuit (e.g., the adaptive drive logic 338) to cause a multiplexer (e.g., the multiplexer 342) to cease providing a first signal associated with a first slew rate control setting (e.g., HI. EFFICIENCY SETTING) as the control signal and begin providing a second signal associated with a second slew rate control setting (e.g., ADAPTIVE SETTING) as the control signal. For certain aspects, the operations 500 further include the power supply circuit sensing an output current (e.g., Iload) of the switching regulator power stage. In this case, when the output current is less than a threshold current, the power supply circuit may reset the latch circuit to cause the multiplexer to cease providing the second signal as the control signal and begin providing the first signal as the control signal.

According to certain aspects, the operations 500 further involve the power supply circuit effectively disabling an input voltage sensing circuit (e.g., input voltage sensing circuit 308) when the power supply circuit is in a pulse-skipping mode. In this case, sensing the input voltage level at block 504 may include sensing the input voltage level using the input voltage sensing circuit.

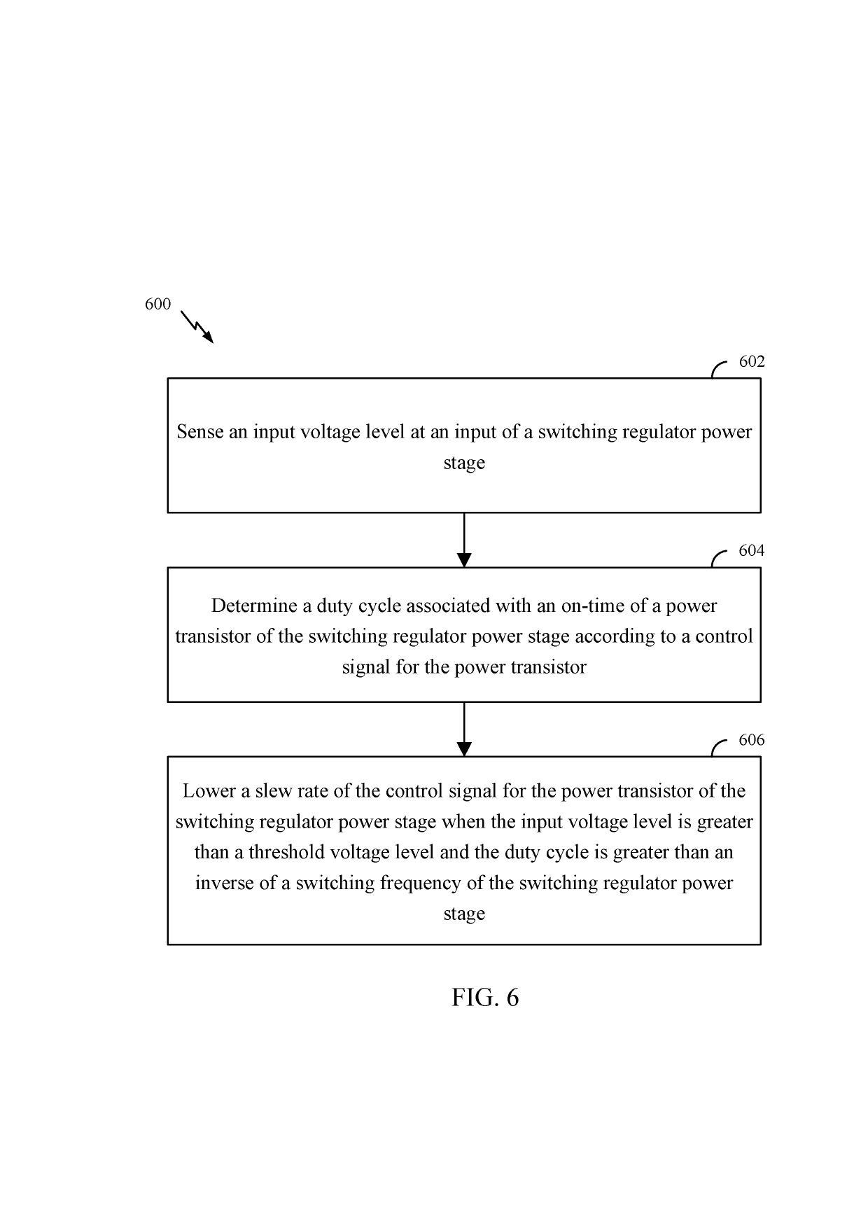

FIG. 6 is another flow diagram of example operations 600 for supplying power, in accordance with certain aspects of the present disclosure. The operations 600 may be performed by a power supply circuit (e.g., the power supply circuits 300 of FIGS. 3A-3C).

The operations 600 may begin, at block 602, with the power supply circuit sensing an input voltage level at an input (e.g., input 204) of a switching regulator power stage (e.g., switching regulator power stage 202). For instance, an input voltage sensing circuit (e.g., input voltage sensing circuit 308) may be used to sense the input voltage level.

At block 604, the power supply circuit may determine a duty cycle associated with an on-time of a power transistor (e.g., high-side transistor 206) of the switching regulator power stage according to a control signal (e.g., HS_IN) for the power transistor.

At block 606, the power supply circuit may lower a slew rate of the control signal for the power transistor of the switching regulator power stage when the input voltage level is greater than a threshold voltage level (e.g., V2) and the duty cycle is greater than an inverse of a switching frequency of the switching regulator power stage (e.g., greater than the switching period).

### Example Aspects

In addition to the various aspects described above, specific combinations of aspects are within the scope of the disclosure, some of which are detailed below:

Aspect 1: A power supply circuit comprising: a power supply rail; a switching regulator power stage comprising a power transistor and an input coupled to the power supply rail; a transient voltage sensing circuit having an input coupled to the power supply rail; an input voltage sensing circuit having an input coupled to the power supply rail; and control logic having an output coupled to a gate of the power transistor, a first input coupled to an output of the transient voltage sensing circuit, and a second input coupled to an output of the input voltage sensing circuit.

Aspect 2: The power supply circuit of Aspect 1, wherein the transient voltage sensing circuit comprises: a filter having an input coupled to the power supply rail; a transistor having a gate coupled to an output of the filter and a source coupled to the power supply rail; and a comparator having an input coupled to a drain of the transistor and an output coupled to the first input of the control logic.

Aspect 3: The power supply circuit of Aspect 2, wherein the comparator comprises a Schmitt trigger.

Aspect 4: The power supply circuit of any of Aspects 1 to 3, wherein the input voltage sensing circuit comprises: a voltage divider having an input coupled to the power supply rail; and a comparator having a first input coupled to a tap of the voltage divider, a second input coupled to a reference voltage source, and an output coupled to the second input of the control logic.

Aspect 5: The power supply circuit of any of Aspects 1 to 4, further comprising: a switching device coupled between the power supply rail and the input of the input voltage sensing circuit.

Aspect 6: The power supply circuit of any of Aspects 1 to 5, further comprising: a driver circuit coupled between the output of the control logic and the gate of the power transistor, wherein the control logic comprises: a latch circuit having the first input and the second input; a first register configured to store a first slew rate control setting; a second register configured to store a second slew rate control setting; and a multiplexer having a control input coupled to an output of the latch circuit, a first input coupled to the first register, a second input coupled to the second register, wherein the driver circuit has a signal input coupled to the output of the control logic, a control input coupled to an output of the multiplexer, and an output coupled to the gate of the power transistor.

Aspect 7: The power supply circuit of any of Aspects 1 to 6, wherein the control logic is configured to lower a slew rate of a control signal for the power transistor from a first slew rate to a second slew rate when a transient voltage level sensed by the transient voltage sensing circuit is greater than a first threshold voltage level and an input voltage level sensed by the input voltage sensing circuit is greater than a second threshold voltage level.

Aspect 8: The power supply circuit of Aspect 7, wherein the control logic has a third input coupled to an output of the switching regulator power stage and is further configured to: receive an indication of an output current of the switching regulator power stage via the third input; and raise the slew rate of the control signal for the power transistor from the second slew rate to the first slew rate when the output current of the switching regulator power stage is below a threshold current.

Aspect 9: The power supply circuit of any of Aspects 1 to 8, wherein the control logic is configured to lower a slew rate of a control signal for the power transistor from a first slew rate to a second slew rate when an input voltage level sensed by the input voltage sensing circuit is greater than a threshold voltage level and a duty cycle associated with an on-time of the power transistor according to the control signal is greater than an inverse of a switching frequency of the switching regulator power stage.

Aspect 10: A method of supplying power with a power supply circuit, comprising: sensing a transient voltage level at an input of a switching regulator power stage; sensing an input voltage level at the input of the switching regulator power stage; and when the transient voltage level is greater than a first threshold voltage level and the input voltage level is greater than a second threshold voltage level, lowering a slew rate of a control signal for a power transistor of the switching regulator power stage.

Aspect 11: The method of Aspect 10, further comprising: subsequent to the lowering, sensing an output current of the switching regulator power stage; and when the output current is less than a threshold current, increasing the slew rate of the control signal for the power transistor.

Aspect 12: The method of Aspect 10 or 11, further comprising: determining a duty cycle associated with an on-time of the power transistor according to the control signal for the power transistor of the switching regulator power stage; and when the duty cycle is greater than an inverse of a switching frequency of the switching regulator power stage, lowering the slew rate of the control signal for the power transistor of the switching regulator power stage.

Aspect 13: The method of any of Aspects 10 to 12, further comprising: raising the slew rate, subsequent to the lowering, when at least one of: the transient voltage level is no longer greater than the first threshold voltage level; the input voltage level is no longer greater than the second threshold voltage level; the power supply circuit enters a pulse-skipping mode; or after a programmable period has elapsed.

Aspect 14: The method of any of Aspects 10 to 13, wherein lowering the slew rate comprises: setting a latch circuit to cause a multiplexer to cease providing a first signal associated with a first slew rate control setting as the control signal and begin providing a second signal associated with a second slew rate control setting as the control signal.

Aspect 15: The method of Aspect 14, further comprising: sensing an output current of the switching regulator power stage; and when the output current is less than a threshold current, resetting the latch circuit to cause the multiplexer to cease providing the second signal as the control signal and begin providing the first signal as the control signal.

Aspect 16: The method of any of Aspects 10 to 15, further comprising: effectively disabling an input voltage sensing circuit when a power supply circuit comprising the switching regulator power stage is in a pulse-skipping mode, wherein sensing the input voltage level comprises sensing the input voltage level using the input voltage sensing circuit.

Aspect 17: An apparatus comprising: means for sensing a transient voltage level at an input of a switching regulator power stage; means for sensing an input voltage at the input of the switching regulator power stage; and means for lowering a slew rate of a control signal for a power transistor of the switching regulator power stage when the transient voltage level is greater than a first threshold and the input voltage is greater than a second threshold.

Aspect 18: A method of supplying power, comprising: sensing a transient voltage level at an input of a switching regulator power stage; sensing an input voltage level at the input of the switching regulator power stage; determining a duty cycle associated with an on-time of a power transistor of the switching regulator power stage according to a control signal for the power transistor; and lowering a slew rate of the control signal for the power transistor of the switching regulator power stage when at least one of: the transient voltage level is greater than a first threshold voltage level and the input voltage level is greater than a second threshold voltage level; or the input voltage level is greater than the second threshold voltage level and the duty cycle is greater than an inverse of a switching frequency of the switching regulator power stage.

Aspect 19: A method of supplying power, comprising: sensing an input voltage level at an input of a switching regulator power stage; determining a duty cycle associated with an on-time of a power transistor of the switching regulator power stage according to a control signal for the power transistor; and when the input voltage level is greater than a threshold voltage level and the duty cycle is greater than an inverse of a switching frequency of the switching regulator power stage, lowering a slew rate of the control signal for the power transistor of the switching regulator power stage.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

For example, means for sensing a transient voltage level at an input of a switching regulator may include a transient voltage detector (e.g., transient voltage sensing circuit 302 as illustrated in FIGS. 3A-3C). Means for sensing an input voltage at the input of the switching regulator may include an input voltage detector (e.g., input voltage sensing circuit 308 as depicted in FIGS. 3A-3C). Means for lowering a slew rate of a control signal for a power transistor of the switching regulator when the transient voltage level is greater than a first threshold and the input voltage is greater than a second threshold may include a logic circuit, such as the control logic 314 portrayed in FIGS. 3A-3C.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a power supply rail;
a switching regulator power stage comprising a power transistor and an input coupled to the power supply rail;
a transient voltage sensing circuit having an input coupled to the power supply rail;
an input voltage sensing circuit having an input coupled to the power supply rail; and
control logic having an output coupled to a gate of the power transistor, a first input coupled to an output of the transient voltage sensing circuit, and a second input coupled to an output of the input voltage sensing circuit.

2. The power supply circuit of claim 1, wherein the transient voltage sensing circuit comprises:
a filter having an input coupled to the power supply rail;
a transistor having a gate coupled to an output of the filter and a source coupled to the power supply rail; and
a comparator having an input coupled to a drain of the transistor and an output coupled to the first input of the control logic.

3. The power supply circuit of claim 2, wherein the comparator comprises a Schmitt trigger.

4. The power supply circuit of claim 1, wherein the input voltage sensing circuit comprises:
a voltage divider having an input coupled to the power supply rail; and
a comparator having a first input coupled to a tap of the voltage divider, a second input coupled to a reference voltage source, and an output coupled to the second input of the control logic.

5. The power supply circuit of claim 1, further comprising:
a switching device coupled between the power supply rail and the input of the input voltage sensing circuit.

6. The power supply circuit of claim 1, further comprising a driver circuit coupled between the output of the control logic and the gate of the power transistor, wherein the control logic comprises:
a latch circuit having the first input and the second input;
a first register configured to store a first slew rate control setting;
a second register configured to store a second slew rate control setting; and
a multiplexer having a control input coupled to an output of the latch circuit, a first input coupled to the first register, and a second input coupled to the second register, wherein the driver circuit has a signal input coupled to the output of the control logic, a control input coupled to an output of the multiplexer, and an output coupled to the gate of the power transistor.

7. The power supply circuit of claim 1, wherein the control logic is configured to lower a slew rate of a control signal for the power transistor from a first slew rate to a second slew rate when a transient voltage level sensed by the transient voltage sensing circuit is greater than a first threshold voltage level and an input voltage level sensed by the input voltage sensing circuit is greater than a second threshold voltage level.

8. The power supply circuit of claim 7, wherein the control logic has a third input coupled to an output of the switching regulator power stage and is further configured to:
receive an indication of an output current of the switching regulator power stage via the third input; and
raise the slew rate of the control signal for the power transistor from the second slew rate to the first slew rate when the output current of the switching regulator power stage is below a threshold current.

9. The power supply circuit of claim 1, wherein the control logic is configured to lower a slew rate of a control signal for the power transistor from a first slew rate to a second slew rate when an input voltage level sensed by the input voltage sensing circuit is greater than a threshold voltage level and a duty cycle associated with an on-time of the power transistor according to the control signal is greater than an inverse of a switching frequency of the switching regulator power stage.

10. A method of supplying power with a power supply circuit, comprising:
sensing a transient voltage level at an input of a switching regulator power stage;
sensing an input voltage level at the input of the switching regulator power stage; and
when the transient voltage level is greater than a first threshold voltage level and the input voltage level is greater than a second threshold voltage level, lowering a slew rate of a control signal for a power transistor of the switching regulator power stage.

11. The method of claim 10, further comprising:
subsequent to the lowering, sensing an output current of the switching regulator power stage; and
when the output current is less than a threshold current, increasing the slew rate of the control signal for the power transistor.

12. The method of claim 10, further comprising:
determining a duty cycle associated with an on-time of the power transistor according to the control signal for the power transistor of the switching regulator power stage; and
when the duty cycle is greater than an inverse of a switching frequency of the switching regulator power stage, lowering the slew rate of the control signal for the power transistor of the switching regulator power stage.

13. The method of claim 10, further comprising:
raising the slew rate, subsequent to the lowering, when at least one of:
the transient voltage level is no longer greater than the first threshold voltage level;
the input voltage level is no longer greater than the second threshold voltage level;
the power supply circuit enters a pulse-skipping mode; or
after a programmable period has elapsed.

14. The method of claim 10, wherein lowering the slew rate comprises:
setting a latch circuit to cause a multiplexer to cease providing a first signal associated with a first slew rate control setting as the control signal and begin providing a second signal associated with a second slew rate control setting as the control signal.

15. The method of claim 14, further comprising:
sensing an output current of the switching regulator power stage; and
when the output current is less than a threshold current, resetting the latch circuit to cause the multiplexer to cease providing the second signal as the control signal and begin providing the first signal as the control signal.

16. The method of claim 10, further comprising:
effectively disabling an input voltage sensing circuit when the power supply circuit is in a pulse-skipping mode, wherein sensing the input voltage level comprises sensing the input voltage level using the input voltage sensing circuit.

17. A method of supplying power, comprising:
sensing a transient voltage level at an input of a switching regulator power stage;
sensing an input voltage level at the input of the switching regulator power stage;
determining a duty cycle associated with an on-time of a power transistor of the switching regulator power stage according to a control signal for the power transistor; and
lowering a slew rate of the control signal for the power transistor of the switching regulator power stage when at least one of:
the transient voltage level is greater than a first threshold voltage level and the input voltage level is greater than a second threshold voltage level; or
the input voltage level is greater than the second threshold voltage level and the duty cycle is greater than an inverse of a switching frequency of the switching regulator power stage.
